(19) United States
(12) Patent Application Publication
(10) Pub. No.: US 2024/0383039 A1
(43) Pub. Date: Nov. 21, 2024

(54) ADDITIVE MANUFACTURING USING IOINIZED PARTICLES

(71) Applicant: The Board of Regents for the Oklahoma Agricultural and Mechanical Colleges, Stillwater, OK (US)

(72) Inventor: Aaron S. Alexander, Glencoe, OK (US)

(73) Assignee: The Board of Regents for the Oklahoma Agricultural and Mechanical Colleges, Stillwater, OK (US)

(21) Appl. No.: 18/693,768

(22) PCT Filed: Oct. 24, 2022
(86) PCT No.: PCT/US2022/047594

§ 371 Date: Mar. 20, 2024

Related U.S. Application Data
(60) Provisional application No. 63/272,493, filed on Oct. 27, 2021.

(51) Int. Cl. B22F 10/25; B22F 12/90; B33Y 10/00; B33Y 40/10

(52) U.S. Cl. CPC B22F 10/25; B22F 12/90; B22F 2999/00; B33Y 10/00; B33Y 40/10

(57) ABSTRACT

A method and system of 3D cold-spray printing to produce an object by adhering powder grains to a substrate. The powder grains are ionized by injecting the powder grains into an ionizing mechanism to produce ionized powder grains. Next, the ionized powder grains are focused into a stream using an electromagnetic lens, wherein the stream has a thickness approaching the average diameter of the powder grain. The stream is directed at a substrate such that powder grains are deposited on and adhered to the substrate.

### CROSS-REFERENCE TO RELATED APPLICATION

This application claims the benefit of U.S. Provisional Application 63/272,493 filed Oct. 27, 2021, which is hereby incorporated by reference.

### FIELD

The present invention relates generally to 3D printing, more specifically to improvements in 3D-printing speed and resolution.

### BACKGROUND

Key technological developments and advances in manufacturing have been made in recent years with the increasingly widespread use of three-dimensional (3-D) printing for a variety of applications. Such applications are especially prevalent in the context of manufacturing numerous types of sophisticated mechanical structures. Similar advances have recently been made, and milestones achieved, relative to the advancement of 3-D printing technologies themselves. A small representative selection of advances in 3-D printing technologies are CN208116755U; CN104985813A; WO2020010109A1 (filed in the US as US20200009657A1); WO2020023424A1 (filed in the US as US20200033833A1); KR20190067814A; US20190316262A1; US20180050391A1 and US20180133956A1, the disclosures of which are incorporated by reference.

Unfortunately, Modern 3D printers' low print speed limits them to use in creating prototypes or in limited batch manufacturing. As an example, the fastest current metal printers can print a volume of about 60 cm³/hr per nozzle or laser. This is equivalent to about 8 grams/minute for a stainless-steel material.

One example of 3-D printing may use cold-spray forming as part of a manufacturing process of components. Cold spray is a manufacturing technique wherein powder grains, usually of metal, are accelerated to speeds approaching or exceeding sonic velocities to impact on a substrate. The high speed of the powder grains causes them to adhere onto the substrate by plastic deformation. Traditionally, this has been used to build up material onto broken parts so that that they could be re-machined before returning the part to service. Recently, organizations have developed 3D printers using cold spray techniques that are capable of enough precision to generate full 3D-printed parts at speeds on the order of kilograms per hour. Such 3D printers typically use powder grains accelerated by high speed air streams. While they are able to focus the streams well enough to generate parts, the precision is still relatively low and the surface finish is poor compared to other 3D-printing processes. This is because the air stream can only be focused so fine before coherence problems start to occur due to high back pressure, turbulence, and limits on the size of the air jet.

Accordingly, it would be advantageous to develop 3D-printing techniques that improve upon the resolution and/or speed of the production of parts.

### SUMMARY

This disclosure remedies this low speed issue while improving on part resolution by providing a 3D-printing system and process using cold spray. In the system and process, powder grains are ionized after being injected by giving the powder grains a linear motion into an ionizing mechanism, such as by a sub-sonic or super-sonic airstream, vibratory motion, a screw feed, or similar means. Subsequently, the ionized powder grains can then be focused into a stream (typically a beam or flat sheet) using an electromagnetic lens (such as quadrupole magnets in a series arrangement), wherein the stream has a thickness (i.e., beam has a diameter, or the flat sheet has a thickness), approaching the average diameter of the powder grain, typically of less than 50 times, less than 10 times, less than 5 times or about the average diameter of the powder grain. For example, some powder grains can be on the order of 0.1 mm or less, or can be no larger than about 0.05 mm, no larger than about 0.03 mm, no larger than about 0.02 mm, or no larger than about 0.015 mm; also, such grains can be larger than 0.00001 mm, or larger than 0.0001 mm. The beam (or flat sheet) is subsequently directed at a substrate such that powder grains are deposited on and adhere to the substrate.

The above system and method can be further refined by many options. For example, in the system and method, the ionized powder grains can be steered using magnetic or electrostatic deflection yokes to achieve highly precise targeting of the powder stream. For example, one or more magnets can be used, which may be electromagnets or permanent magnets. In some embodiments, the steering can be by one or more electric fields.

After focusing, the ionized powder grains can then be further accelerated using magnetic fields and/or electric fields to the speed needed to properly weld the powder material in the cold spray process.

Alternatively, the powder grains can be injected in packets that are then accelerated using either a pulsed electric field or magnetic induction in a varying magnetic field. The accelerated ionized powder grains can achieve additional acceleration by using either a magnetic deflection yoke, electrostatic yoke, or quadrupole electromagnet to divert the powder grain packets in a circular path back through the pulsed electric or magnetic fields. The powder can be separated into packets by pausing the injection process to time the packets to meet up with the electrodynamic or magnetic induction pulses at the proper time. Alternatively, the packets are achieved by using a switching magnetic dipole or electrostatic yoke to send ionized powder packets through alternative paths causing gaps to be created in between packets following any of the particular paths. Each of the packets can then be accelerated as described above. Additionally, the packets can be combined back together after acceleration using either a dipole or quadrupole electromagnet.

The powder grains can be in an air stream prior to ionization, and a magnetic or electrostatic yoke can deflect the powder stream out of the air stream before sending it towards the substrate in the printing process.

The process can be carried out in a vacuum or low-pressure environment in order to remove imprecision caused by the turbulent effects of air and reduce oxidation during the process.

The system and process can include injecting an inert gas to surround the powder grains to reduce combustion risk and/or other oxidative effects.

A camera can be used to identify the strike point of the powder stream on the substrate and using the magnetic or electrostatic yoke to adjust the positioning to match up with the intended location from a drawing or instructions.

The ionized powder grains can be de-ionized before being sent to impact the substrate in order to avoid Faraday cage deflection.

The powder grains of two or more different powder materials can be combined in the stream to modify the properties of the final part produced from depositing the powder grains on the substrate.

The powder discharge rate can be measured using the voltage induced by the ionized powder grains passing through a coil.

The speed of the printer nozzle can be modified based on the measured quantity of material being emitted to ensure that the print matches up with the specified drawing or instructions.

The relative charge of powder grains can be measured, tracked, and/or filtered in order to tune the magnetic or electrostatic steering yoke to properly direct the powder grain to the desired final position.

The steering of the ionized powder grains by the magnetic yoke can be tuned using machine learning by using a camera system to observe the behavior of the powder grains as a range of inputs are applied to the electromagnets of the magnetic deflection yoke. This allows a machine learning algorithm to learn the path and destination for powder grains with a certain charge given a set of inputs to the magnetic deflection yoke.

### BRIEF DESCRIPTION OF THE DRAWINGS

The drawings included in this disclosure illustrate certain aspects of the embodiments described herein. However, the drawings should not be viewed as exclusive embodiments. The subject matter disclosed herein is capable of considerable modifications, alterations, combinations, and equivalents in form and function, as well being evident to those skilled in the art with the benefit of this disclosure. Additionally, the drawings are not to scale.

FIG. 1 is a schematic illustration of a cold spray 3D printer of the prior art.

FIG. 2 is a schematic illustration of three partially formed 3D objects on a plate-like substrate in accordance with the prior art.

FIG. 3 is a schematic illustration of a system/method for imparting a charge on the particles or grains.

FIG. 4 is a schematic illustration of a system/method for focusing charged grains.

FIG. 5 is a schematic illustration of a system/method for accelerating charged grains.

FIG. 6 is a schematic illustration of a system/method for steering or directing a stream of charged grains.

FIG. 7 is schematic illustration of three partially formed 3D objects on a plate-like substrate in accordance with the present disclosure.

### DETAILED DESCRIPTION

The present disclosure may be understood more readily by reference to this detailed description as well as to the examples included herein. In addition, numerous specific details are set forth in order to provide a thorough understanding of the embodiments and examples described herein. However, those of ordinary skill in the art will understand the embodiments and examples described herein can be practiced without these specific details. In other instances, methods, procedures and components have not been described in detail so as not to obscure the related relevant feature being described. Also, the description is not to be considered as limiting the scope of the embodiments described herein.

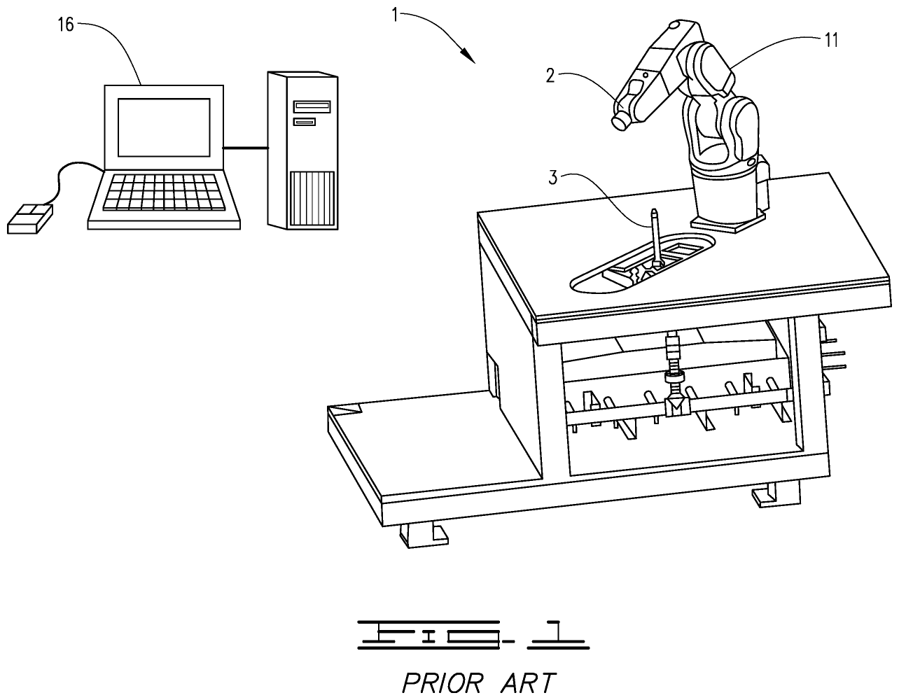

Referring to FIG. 1, a cold spray 3D printer 1 of the prior art is illustrated. Printer 1 has an applicator comprising a nozzle 2 for dispensing a spray of suitable metallic powder at high velocity. Nozzle 2 can be stationary or optionally connected to a first robotic arm 11. The metallic powder is sprayed at a substrate (not shown in FIG. 1) held by substrate holder comprising a second robotic arm 3 to create a 3D object. More specifically, the object is formed from a series of parallel layers sprayed one after the other.

The second robotic arm 3 is preferably such that it can move the substrate and therefore the part-formed 3D object in different directions and to different angles. If nozzle 2 is connected to first robotic arm 11, nozzle 2 may thereby be moveable to spray in different directions or at different angles.

The printer of FIG. 1 incorporates or is connected with a computerized controller 16. This gives directions to progressively adjust the distance and angle between the nozzle 2 and/or first robotic arm 11 and/or second robotic arm 3 to enable the 3D object to be printed. This may include ensuring the nozzle is orthogonal to the surface it is working on. In this regard the controller 16 runs software that interacts with a data file (e.g. in .STL form) defining the shape of the 3D object. In other words, the data provides a set of instructions to the software.

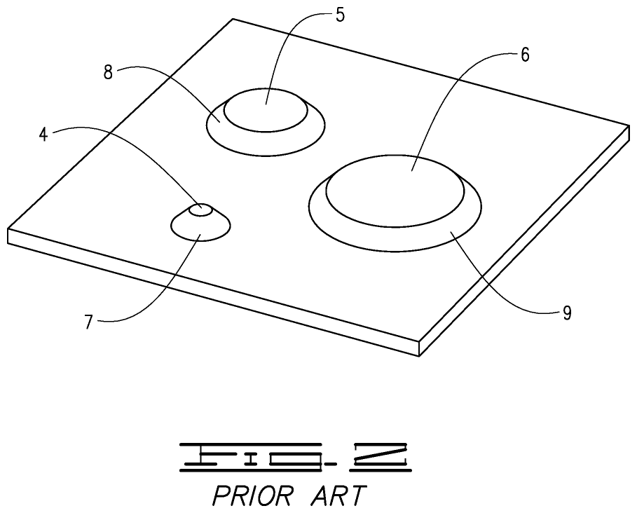

FIG. 2 shows the first layer 4, 5, and 6 of three partially formed 3D objects on a plate-like substrate. Deposited in accordance with the prior art. In such prior art systems, as the spray particles travel from the nozzle 2 in a conical shape, they are more concentrated and move faster at the center than at the periphery. As a consequence, the deposition of powder is not uniform. This causes the layers 4, 5, and 6 to have inwardly tapered edges 7, 8 and 9. The tapers are less than desirable if, for example, one wishes to make an object with straight edges, such as a cylinder, or some other profile.

As will be realized from the above, the prior art system has problems with producing high resolution items because of the coarse movements of the robotic arms and the non-uniform deposition of metallic spray as described above. This disclosure solves the problem of poor printing resolution by ionizing material grains (powder grains). The methods and systems of this disclosure can be incorporated into systems such as the one shown in FIG. 1 or other spray printing systems. The method and systems of this disclosure provide for finer control of the spray direction and angles than allowed by the prior art systems and provide for finer resolutions than achieved by the prior art systems. The method and systems of this disclosure can be used instead of the first robotic and/or the second robotic arm, or can be used in addition to one or both robotic arms. Generally, the method and systems will be used with a controller, such as controller 16.

Under the systems and methods of this disclosure, the powder grains are first ionized. Once ionized, the powder grains are then to accelerated and/or steered by electric/magnetic fields similar to the way electrons are accelerated and steered in a CRT (cathode-ray tube) or a particle accelerator. The steering process allows for the creation of very narrow particle streams which, when impacted on a grounded substrate, enables highly precise targeting for a fine resolution and smooth surface. Additionally, increased accuracy/precision of the print can be achieved by separating the particles from the air stream before impacting the substrate using an electromagnetic yoke to turn the powder grains into a separate passageway. There are many powders known for cold spraying and those skilled in the art will be familiar with these. Generally, any material that can be formed using a cold weld process and has powder that can be ionized is suitable to be used in the disclosed printing process and system.

The 3D-printing method and system of this disclosure will now be described in more detail. The 3D-method and system are the type that utilizes a cold spray to produce an object by adhering powder grains to a substrate. Cold spray 3D printing (also called cold spray additive manufacturing) is a coating deposition method. In the methods and systems of the current disclosure solid powders (typically having particles with average diameter of about 100 micrometers ((0.1 mm) or less—generally a D50 average diameter) are accelerated to velocities up to about 1200 m/s. For example, the velocity might be about 100 m/s to about 1200 m/s, or about 200 m/s to about 800 m/s. During impact with the substrate, particles undergo plastic deformation and bond together while adhering to the surface to create a layer. To achieve a uniform thickness, methods and systems of this invention, utilize streams of particles which are electrically or magnetically directed so as to be scanned along the substrate in a predetermined configuration to build up layers of particles to produce the final product.

Generally, the cold spraying printing of this disclosure has the steps of injecting the powder grains, ionizing the grains, focusing the grains, accelerating the grains, and directing or steering the grains. For example, the powder grains can first be injected into the system by a sub-sonic or super-sonic airstream or a mechanical injection means such as a vibratory system or screw feed. The purpose the injection is to pickup grains from their storage or containment area and impart to them motion to introduce them into an ionizing zone.

Thus in some embodiments, the powder grains will be in a stream of air or inert gas prior to ionization, the gas is used to aid in moving the powdered grains through the ionizing mechanism. Later in the process the ionized powder grains can be deflected out of the air stream before being directed towards the substrate, such as by using a magnetic or electrostatic yoke.

In alternative embodiments, mechanical injection is used, and in some of these embodiments, the process is carried out in a vacuum or low-pressure environment (less than 1 atm, and more typically, no greater than 0.75 atm, no greater than 0.5 atm, no greater than 0.25 atm, or no greater than 0.1 atm).

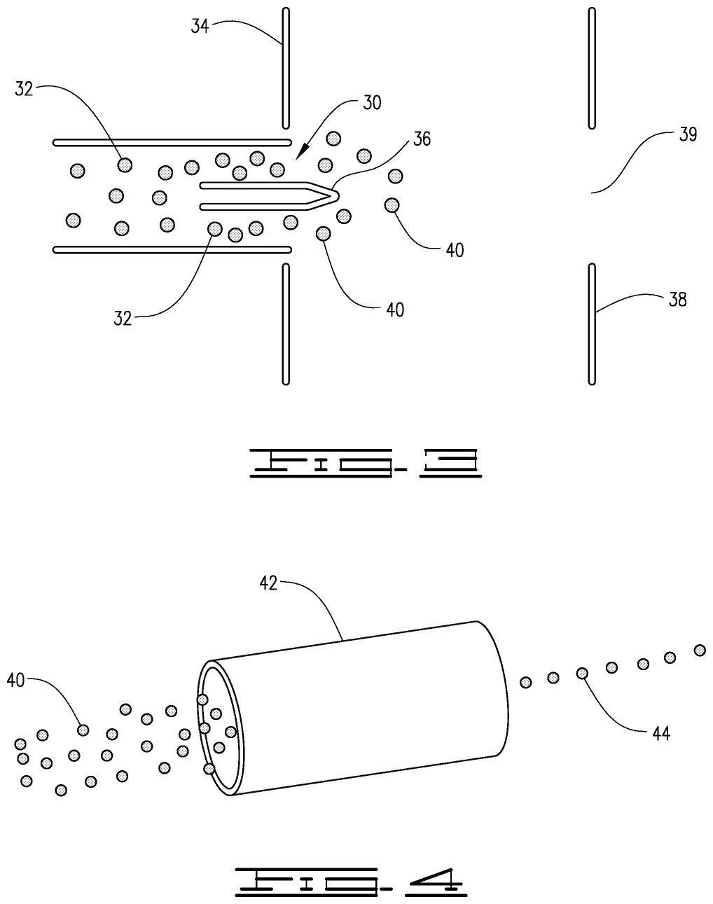

These injected grains enter an ionizing zone so as to impart a charge on the particles to produce ionized powder grains. For example, in FIG. 3 the injected grains 32 are introduced into ionizing zone 30, which is formed by high electrical-potential plate 34, and electrode 36. As will be understood, there is generated an electrical-potential difference between high-potential plate 34 and electrode 36 so that the injected grains 32 are charged as they pass in through the ionizing zone 30 located between and around high electrical-potential plate 34. The thus formed ionized powder grains 40 then pass through gap 39 in grounding plate 38. Additionally, the grounding plate can accelerate the ionized powder grains by electromagnetic attraction.

These ionized grains are then focused into a stream (such as a beam or a flat sheet) using an electromagnetic lens. As used herein, “beam” refers to a cylindrical shaft of the ionized grains, and “flat sheet” refers to a stream of particles that has a width greater than its thickness, typically, the width will be 5 times or more of the thickness, or 10 times or more of thickness. While the width can be many thousand of time of the thickness (10,000 times or more), generally it will be less than 1000 times the thickness.

Generally, focusing can be carried out using electrostatic or magnetic lenses. For example, an electromagnetic lens such as a magnetic coils or quadrupole magnets in a series arrangement can be used. Thus in FIG. 4, the ionized powder particles 40 are passed through electrical magnetic lens 42 to produce a narrow stream 44 of the ionized grains. As discussed herein, the narrow stream typically will be a beam or a sheet of the ionized powder particles. Hereinafter, sometimes only the term beam will be used but it should be understood that the description applies to both the beam and flat sheet, unless otherwise indicated.

The narrow stream has a thickness (diameter for the beam or thickness for the sheet) approaching the average diameter of the powder grain. As used herein “approaching the thickness of the grain” refers to less than 50 times the average diameter of the powder grain, and generally will be less than or no greater than 10 times, less than or no greater than 5 times, or about the average diameter of the powder grain. For example, some powder grains can be on the order of 0.1 mm or less, or can be no larger than about 0.05 mm, no larger than about 0.03 mm, no larger than about 0.02 mm, or no larger than about 0.015 mm; also, such grains can be larger than 0.00001 mm, or larger than 0.0001 mm.

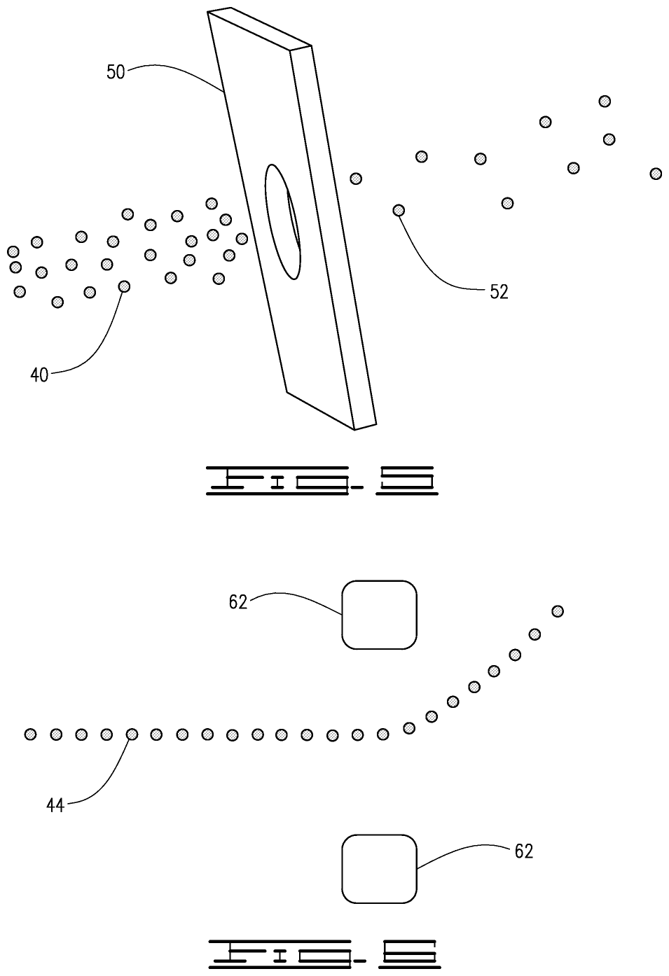

Either before or after focusing, the ionized powder grains can then be further accelerated using an electric field to the speed needed to properly weld the powder material in the cold spray process. Typically, the acceleration will be after focusing. The acceleration can be by a cyclotron or a linear accelerator and/or by a static electrical field, pulsed electric field or magnetic induction in a varying magnetic field. As schematically illustrated in FIG. 5, ionized particles (or ionized grains) 40 are passed through the accelerator represented by charged plate 50 to produce the accelerated stream of ionized particles 52. As will be realized, FIG. 5 illustrates the acceleration of the ionized particles prior to focusing but applies to acceleration after focusing as well.

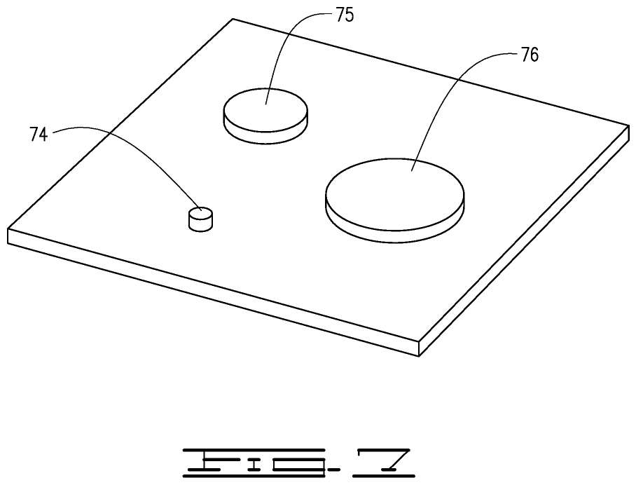

The resulting accelerated and focused beam can then be directed at a substrate such that powder grains are deposited on and adhered to the substrate. For example, the beam is steered using magnetic or electrostatic deflection yokes. As illustrated in FIG. 6, a beam 44 is steered using one or more dipole magnets 62. The directing or “steering” is performed so that the beam impacts the substrate at one or more predetermined locations (“strike point(s)”). These strike points being sites where the powder grains are deposited on and adhere to the substrate, including depositing on and adhering to previously deposited grains on the substrate so as to build up layers of the grains on the substrate.

The focusing and acceleration methods and systems described herein allow for a greatly enhanced resolution of the final product. Thus, FIG. 3 schematically shows a first layer 74, 75, and 76 of three partially formed 3D objects on a plate-like substrate, deposited in accordance with this disclosure. The spray particles travel from the printer nozzle in a beam or sheet shape and thus have a uniform distribution allowing for better resolution. Additionally, the electrically/magnetically focusing and steering allows for more precise deposition of the grains also enhancing resolution. As a consequence, the deposition of powder is very uniform and controlled. Thus, unlike the deposition of FIG. 2, the deposition in FIG. 7 has non-tapered straight edges 77, 78 and 79.

The deposition resolution can be further enhanced by using a controller, drawings or instructions, and a camera. For example, in some embodiments, the camera can be utilized to identify a strike point. For example, the controller, similar to controller 6 shown in FIG. 1, can be used in conjunction with the camera to locate strike points on the substrate based off of drawings or other instructions utilized by the controller. After a strike point is located, the controller can send signals to direct the beam to the strike point, such as by adjusting the fields produced by magnetic or electrostatic yoke(s) to adjust the beam to the positioning of the strike point.

In some embodiments, the beam is de-ionized before impacting the substrate in order to avoid Faraday cage deflection.

The herein described systems and methods can be used to accelerate the grains to velocities up to about 1200 m/s. For example, the velocity might be about 100 m/s to about 1200 m/s, or about 200 m/s to about 800 m/s. During impact with the substrate, particles undergo plastic deformation and bond together while adhering to the surface to create a layer. As described above, the electrical or magnetic direction of the particle beam allows precise control and greater control than past techniques used in 3D cold spraying, so that the methods and systems of this disclosure achieve a uniform thickness.

The method and systems of this disclosure include embodiments where the ionized powder grains are injected in packets comprising groups of particles. For example, the powder can be separated into packets by pausing the injection process to time the packets to meet up with the electrodynamic or magnetic induction pulses at the proper time. For example, the packets can be achieved by using a switching magnetic dipole or electrostatic yoke to send ionized powder packets through alternative paths causing gaps to be created in between packets following any of the particular paths.

These packets can be accelerated using either a pulsed electric field or magnetic induction in a varying magnetic field. Additionally, the ionized powder grains can achieve additional acceleration by using either a magnetic deflection yoke, electrostatic yoke, or quadrupole electromagnet to divert the powder grain packets in a circular path back through the pulsed electric or magnetic fields. In some of these embodiments, the packets are combined back together after acceleration, such as by using either a dipole or quadrupole electromagnet.

In some embodiments, the powder grains include two or more different powder materials (such as two different metals), which are combined in the stream to modify the properties of a final part produced by depositing the powder grains on the substrate. During the process, the ratios of these different materials can be adjusted as needed for different portions of the final product to be produced.

During the process, the powder discharge rate can be measured using the voltage induced by the ionized powder grains passing through a coil. Accordingly, the speed resulting from the acceleration of the particles can be modified to adjust the rate based on the measured quantity of material being emitted to ensure that the print matches up with the specified drawing or instructions.

Also, the relative charge of powder grains can be measured, tracked, and/or filtered in order to tune the magnetic or electrostatic steering yoke to properly direct the powder grain to the desired final position.

The steering of the ionized powder grains by the magnetic yoke can be tuned using machine learning by using a camera system to observe the behavior of the powder grains as a range of inputs are applied to the electromagnets of the magnetic deflection yoke. This allows a machine learning algorithm to learn the path and destination for powder grains with a certain charge given a set of inputs to the magnetic deflection yoke.

A typical electrostatic powder paint gun can emit 450 g/min of ionized powder. Potentially, this can be increased by re-design of the ionization gun or by incorporating the output of multiple ionizers into a single stream using electric/magnetic field steering and focusing. With just one nozzle, the print rate would be over 50 times faster than the current fastest printers. With this kind of output, 3D printers will start to become practical for large scale manufacturing of products as shown by the current cold-spray 3D printers cited earlier. One transformative part of the herein disclosed invention is the focusing, shaping, and steering of the particle stream. With the techniques described herein, a particle stream will yield much higher resolution printing while allowing for shaping and steering of the stream for improved accuracy and/or coverage.

As outlined above, the process begins by injecting powder grains to be ionized. The powder grains can be injected in various ways including by air stream or by mechanical flinging processes. While grain ionization can be achieved by many different methods, the main three methods are triboelectric charging, corona discharge, and induction. Currently, grain ionization using either corona discharge from an electrode or triboelectric ionization are most typical.

With corona discharge, the maximum possible charge of a grain is represented by the Pauthenier equation:

$$q ( t ) = [ 1 + 2 ( \frac{{ϵ}_{r} - 1}{{ϵ}_{r} + 1} ) ] 4 π {r}^{2} {ϵ}_{0} E ( \frac{t}{t + τ} ) \qquad ( 1 )$$

$${Q}_{max} = \frac{12 {πϵ}_{0} {ϵ}_{r} {r}^{2} E}{{ϵ}_{r} + 2} \qquad ( 2 )$$

$$τ = \frac{4 {ϵ}_{0} E}{J} \qquad ( 3 )$$

where q(t) is the instantaneous charge, Qₘₐₓ is the maximum possible charge, τ is the time constant which is the time it takes to reach half of the maximum charge, r is the powder grain radius (m), ϵ₀≈8.854×10⁻¹² F/m is the vacuum permittivity, ϵᵣ is the relative permittivity of the powder grain material (=∞ for metals), and E is the electric field (V/m).

Table 1 list parameters representative of corona charging parameters. Using the example values shown in Table 1 for a 10-micron particle, the maximum charge is on the order of 10⁻¹³ C, while a more practical expectation is on the order of 10⁻¹⁵ C. A reduced particle size will give a smaller charge, but the reduced mass of the particle reduces the time and distance needed for acceleration while improving the focusing and steering ability.

TABLE 1

| | |
|---|---|
| Example 1 | Example 2 |

Corona Charging Parameters

| | | | | |
|---|---|---|---|---|
| Grain Diameter: | 1.0E−06 | m | 7.0E−08 | m |
| Material Density: | 4200 | kg/m\hat{ }3 | 4200 | kg/m\hat{ }3 |
| Mass of Grain: | 2.20E−15 | kg | 7.54E−19 | kg |
| Vacuum Permittivity, ε₀: | 8.85E−12 | F/m | 8.85E−12 | F/m |
| Relative Permittivity, εᵣ: | 1000 | F/m | 1000 | F/m |
| Voltage Differential: | 75000 | V | 75000 | V |
| Electrode to Ground Dist: | 0.2 | m | 0.2 | m |
| Electrical Field Strength, E: | 3.75E+05 | V/m | 3.75E+05 | V/m |
| Current Density, J: | 1.00E−04 | A/m\hat{ }2 | 1.00E−04 | A/m\hat{ }2 |
| Time of Contact: | 0.1 | s | 0.1 | s |
| Time Constant, τ: | 0.13 | s | 0.13 | a |
| Maximum Possible Charge: | 3.12E−17 | C | 1.53E−19 | C |
| Grain Charge: | 1.34E−17 | C | 6.58E−20 | C |

Particle Acceleration

| | | | | |
|---|---|---|---|---|
| Plate Voltage Differential: | 75000 | V | 75000 | V |
| Plate Separation Distance: | 0.1 | m | 0.1 | m |
| Desired Final Velocity: | 350 | m/s | 350 | m/s |
| Distance Needed: | 13.382 | m | 0.937 | m |
| Time Needed: | 0.076 | s | 0.005 | s |

In a typical powder spray application, the powder is only ionized over the short distance from the electrode to the grounded substrate. In the application discussed herein, having a higher ionization of the grains will result in better focusing, acceleration, and steering so it is possible that the grains will need to be ionized over a longer time in order to achieve the maximum ionization. This can include pushing the grains through a longer passageway with multiple electrodes or it can include passing the grains past a single electrode multiple times until they achieve the desired charge. Since the grains will be steered or accelerated in a sharper fashion when they have a higher charge, it is possible to use the amount a particle is accelerated as a filter to select for materials that have reached the charge range desired.

Alternatively, the charge generated by induction ionization system is represented by:

$$q ( t ) = C ΔV [ 1 - {e}^{- \frac{σ t}{C}} ] \qquad ( 4 )$$

where C is the self-capacitance of the powder grain(F), ΔV is the electrode voltage difference(V), t is the time the powder grain is in contact with the electrodes (s), and σ is the electrical conductivity of the powder grain(S).

Table 2 list parameters representative of induction charging parameters. Using the values shown in Table 2, it can be shown that a maximum practical charge is dependent upon the size of the particle, but can usually be achieved within 0.1 seconds in an electrical field.

TABLE 2
Induction Charging Parameters

| | | | | |
|---|---|---|---|---|
| Grain Diameter: | 1.00E−05 | m | 7.00E−08 | m |
| Material Density: | 4200 | kg/m\hat{ }3 | 4200 | kg/m\hat{ }3 |
| Mass of Grain: | 2.20E−12 | kg | 7.54E−19 | kg |
| Self-Capacitance: | 5.56E−16 | F | 3.89E−18 | F |
| Vacuum Permittivity, ε₀: | 8.9E−12 | F/m | 8.85E−12 | F/m |
| Relative Permittivity, εᵣ: | 1000 | F/m | 1000 | F/m |
| Electrical Conductivity, σ/m: | 1.45E+06 | S/m | 1.45E+06 | S/m |
| Electrical Conductivity, σ: | 1.45E+01 | S | 1.02E−01 | S |
| Electrical Resistivity, ρ: | 6.70E−07 | Ωm | 6.70E−07 | Ωm |
| Voltage Differential: | 75000 | V | 75000 | V |
| Electrode to Ground Dist: | 0.2 | m | 0.2 | m |
| Electrical Field Strength, E: | 3.75E+05 | V/m | 3.75E+05 | V/m |
| Time of Contact: | 0.1 | s | 0.1 | s |
| Time Constant, τ: | 5.93E−15 | s | 5.93E−15 | s |
| Grain Charge: | 1.7E−15 | C | 8.4E−20 | C |

Particle Acceleration

| | | | | |
|---|---|---|---|---|
| Plate Voltage Differential: | 75000 | V | 75000 | V |
| Plate Separation Distance: | 0.2 | m | 0.2 | m |
| Desired Final Velocity: | 350 | m/s | 350 | m/s |
| Distance Needed: | 210.1 | m | 1.5 | m |
| Time Needed: | 1.2 | s | 0.0084 | s |

Once grain ionization is achieved, then the four mechanisms claimed herein can be accomplished; filtering, focusing, steering, and/or acceleration. The effectiveness of each of these mechanisms is a function of the size and mass of the individual grains. The centerpiece mechanism is the focusing of the material stream. Current cold spray 3D printers can achieve high throughput, but their resolution is their limiting factor. The resolution of the print is dependent on how tight the stream of particle grains can be compressed. In the present invention, a set of two quadrupole magnets spaced apart in series will focus the charged grains into a beam, which may be a cylindrical beam or may be a flat sheet. The minimum stream thickness (diameter or thickness, respectively) is determined by the mass flow rate of the particle stream. Any Brownian diffusion should be minimized by like-charges preventing direct particle collisions for axial dominated laminar flow.

Accurate steering of the particles is controlled by the particle size uniformity and not the particle charge since, as discussed earlier, it is relatively easy to increase the residence time in the ionizing zone to ensure the maximum charge is reached. For particles of the same approximate diameter, the maximum charge will be about the same value. Differing materials will need to be tuned so each particle will have the same acceleration.

A few further advantages of this system are that it will work equally well in a vacuum and/or a low/no gravity environment. This extends the range of applicability to be able to print equally well in space as it does terrestrially.

Therefore, the present compositions and methods are well adapted to attain the ends and advantages mentioned, as well as those inherent therein. The particular examples disclosed above are illustrative only, as the present treatment additives and methods may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered or modified, and all such variations are considered within the scope and spirit of the present treatment additives and methods. While compositions and methods are described in terms of “comprising,” “containing,” “having,” or “including” various components or steps, the compositions and methods can also, in some examples, “consist essentially of” or “consist of” the various components and steps. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

1. A 3D-printing method using cold spray to produce an object by adhering powder grains to a substrate, comprising:
ionizing the powder grains by injecting the powder grains into an ionizing mechanism to produced ionized powder grains;
focusing the ionized powder grains into a stream using an electromagnetic lens, wherein the stream has a thickness approaching the average diameter of the powder grain; and
directing the stream at a substrate such that powder grains are deposited on and adhered to the substrate.

2. The method of claim 1, wherein the stream is either a beam or a flat sheet and the beam has a diameter or the sheet has a thickness of no greater than about 10 times the average diameter of the powder grain.

3. The method of claim 2, wherein after focusing, the ionized powder grains are steered using magnetic or electrostatic deflection yokes.

4. The method of claim 3, wherein after focusing, the ionized powder grains are then further accelerated using a static electric field so the ionized powder grains achieve any needed additional speed to weld the powder material in the cold spray process.

5. The method of claim 4, wherein the ionized powder grains are injected in packets comprising groups of particles that are then accelerated using either a pulsed electric field or magnetic induction in a varying magnetic field.

6. The method of claim 5, wherein the ionized powder grains achieve additional acceleration by using either a magnetic deflection yoke, electrostatic yoke, or quadrupole electromagnet to divert the powder grain packets in a circular path back through the pulsed electric or magnetic fields.

7. The method of claim 6, wherein the powder is separated into packets by pausing the injection process to time the packets to meet up with the electrodynamic or magnetic induction pulses at the proper time.

8. The method of claim 6, wherein the packets are achieved by using a switching magnetic dipole or electrostatic yoke to send ionized powder packets through alternative paths causing gaps to be created in between packets following any of the particular paths.

9. The method of claim 6, wherein the packets are combined back together after acceleration using either a dipole or quadrupole electromagnet.

10. The method of preceding claim 9, wherein the powder grains are in an air stream prior to ionization and wherein a magnetic or electrostatic yoke deflects the ionized powder grains out of the air stream before directing the ionized grains towards the substrate in the printing process.

11. The method of claim 9, wherein the process is carried out in a vacuum or low-pressure environment.

12. The method of claim 9, further comprising injecting an inert gas to surround the powder grains.

13. The method of claim 8, wherein the stream impacts the substrate at a strike point, and further comprising:
identifying the strike point with a camera; and
using the magnetic or electrostatic yoke to adjust the positioning of the strike point.

14. The method of claim 13, wherein the stream is de-ionized before impacting the substrate in order to avoid Faraday cage deflection.

15. The method of claim 14, wherein the powder grains of two or more different powder materials are combined in the stream to modify the properties of a final part produced by depositing the powder grains on the substrate.

16. The method of claim 15, wherein the powder discharge rate is measured using the voltage induced by the ionized powder grains passing through a coil.
